(19) United States
(12) Patent Application Publication
(10) Pub. No.: US 2006/0253350 A1
(43) Pub. Date: Nov. 9, 2006

(54) Method and system for billing and content delivery

(76) Inventors: Frank Falkenhain, Wulfrath (DE); Heiko Thierbach, Nurnberg (DE)

Correspondence Address: MICHAELSON & ASSOCIATES, P.O. BOX 8489, RED BANK, NJ, 07701, US

(21) Appl. No.: 10/546,714

(22) PCT Filed: Mar. 5, 2004
(86) PCT No.: PCT/EP04/02371

§ 371 Date: Jun. 5, 2006

(51) Int. Cl. H04M 15/00

(52) U.S. Cl. 705/34

(57) ABSTRACT

Method and system for event-based billing and content delivery for event-based premium content requested from a terminal (100) by a terminal user delivered via a portal (200). It can be determined whether or not the content is already delivered but deliverable again based on the existence of a digital ticket and/or other criteria. A credit check can be speed up by checking a credit threshold variable outside the billing system.

### FIELD OF THE INVENTION

The invention relates to billing and content delivery. More specifically the invention relates to billing and delivery of event-based premium content by a portal.

### BACKGROUND OF THE INVENTION

Many existing billing models for premium content are based on subscriptions. The need for billing and content delivery solutions, especially event-based billing and content delivery solutions, is growing, especially for content delivered via portals for mobile data networks such as GPRS and UMTS.

U.S. Pat. No. 6,373,933 describes a method for implementing transaction-based billing for telephone services. U.S. Pat. No. 6,373,933 is applicable to telephony networks comprising an intelligent network component, but cannot be used for data networks such as the Internet or mobile data networks.

WO 00/42537 describes a method, which deals with a voucher as a payment utility. This voucher is issued by a service provider and transmitted towards the terminal of the user. A client application (called start up program) must be installed on the terminal. To get the voucher, it is necessary to establish a dial up connection to a special service number (e.g. 0190 in Germany). The connection costs are then written into the voucher and the voucher is transmitted towards the client. The voucher must be kept in duplicate, one at the provider side and one the client side, to prevent misusage. In addition, the voucher needs to be encrypted as well. The voucher acts as a bank account, allowing the user to spend money exceeding the value of the voucher, if the user has a credit line available. A disadvantage of the method of WO 00/42537 is that a ticket needs to be sent to a client. A consequence of this is that special software needs to be running on the client's terminal and encryption is necessary. Other disadvantages are that a negative credit is possible and each transaction requires a user interaction.

US 2003/00235501 describes a method and a system which deals with a ticket for time meter rating, packet meter rating, hit rate session metering, flat rate and complex mixing meter rating. It is necessary that a client self registers himself and buys a ticket from a billing center. A content provider must adapt its application to the billing center. The content provider has the task to retrieve tickets, rate the value of its service and pass the information to account the bill to the billing center. A disadvantage of the method and system of US 2003/00235501 is that self-registration by the client is necessary and a content provider needs to adapt its application. Furthermore the content provider is troubled with ticket handling.

Problem Definition

A solution capable of handling a large number of billing and content delivery requests (e.g. millions per month), the solution moreover being able to allow in some cases subsequent delivery of the same premium content without the customer having to pay for it again, is not available.

Aim of the Invention

The aim of the invention is to provide a solution for billing and content delivery capable of handling a large number of billing and content delivery requests (e.g. millions per month), the solution moreover being able to allow in some cases subsequent delivery of the same premium content without the customer having to pay for it again.

### SUMMARY OF THE INVENTION

According to an aspect of the invention a method, a portal, a system, a billing system and software for billing and content delivery are provided for a content requested to a portal by a terminal of a terminal user. The billing and content delivery can be event-based.

In a first aspect of the invention the method comprises the step of receiving a request for content by a processor in the portal and determining by the processor in the portal whether or not the content is already delivered to the terminal but is deliverable again, which can be based on the existence of a digital ticket stored in a memory in the portal and indicating a digital proof of payment of the content and/or whether or not a time-out is reached which is determined by the processor by reading a time-out value from the memory and/or whether or not a predefined number of downloads is reached which is determined by the processor by reading a number-of-downloads value from the memory. The digital ticket can be deleted from the memory by the processor when the time-out is reached and/or when the predefined number of downloads is reached.

If the content is already delivered but is deliverable again, the method comprises the step of delivering the content from the portal to the terminal via the network.

If the content is not already delivered or is not deliverable again, the method comprises the step of fetching a credit-information data of the terminal user from a credit-information storage arranged to communicate with the portal, the credit-information storage being located separately from a billing system which is arranged to communicate with the portal, and verifying the credit-information data by the processor. The verifying can comprise extracting from the credit-information data a credit threshold variable and checking if the credit threshold variable is at a predetermined value by the processor. If the credit threshold variable is at the predetermined value, a billing credit check can be requested by fetching a billing credit-information data of the terminal user from the billing system and it can be verified by the processor if the billing credit of the terminal user is at a predetermined minimum level. The billing and content delivery can be stopped if the billing credit of the terminal user is at the predetermined minimum level. It is advantageous to verify the credit-information data, because the credit-information storage can be speed-optimized, while the billing credit-information is stored in the relatively slow billing system.

If the content is not already delivered or is not deliverable again, the method further comprises the step of validating the request for content by the processor in the portal. The validating can comprise retrieving in the portal information about the content from an information database connected to the portal. The information can comprise a price for the content. An acceptation page can be sent from the portal to the terminal via the network and can comprise the price for the content and/or means for returning an acceptation statement for the price of the content. The acceptation statement can be retrieved and/or checked in the portal from the terminal. The acceptation statement can include a pin code. The billing and content delivery can be stopped if the acceptation statement is negative or invalid. A digital ticket can be created in the memory by the processor if the acceptation statement is positive and valid.

If the content is not already delivered or is not deliverable again, the method further comprises the step of delivering the content from the portal to the terminal via the network.

If the content is not already delivered or is not deliverable again, the method further comprises the step of billing the content, e.g. by sending a billing data to the billing system. The credit threshold variable can be set to the predetermined value by the processor in the credit-information storage if the billing credit of the terminal user is at the predetermined minimum level. This has the advantage that on a next content request it can be detected (by verifying the credit-information data) that the billing credit is low and thus the billing system needs to do a billing credit check. The billing and content delivery can finish if the billing credit of the terminal user is not at the predetermined minimum level.

The delivering can comprise retrieving in the portal the content from a content provider connected to the portal and/or sending the content from the portal to the terminal. It can be checked by the processor whether or not the content is retrieved intact from the content provider. This had the advantage that the billing and content delivery can be stopped if the content is not retrieved intact from the content provider. The number-of-downloads variable in the memory can be changed by the processor.

In a second aspect of the invention the portal is arranged to perform any of the steps of the method.

In a third aspect of the invention the system comprising a portal and a credit-information storage is arranged to perform any of the steps of the method.

In a fourth aspect of the invention the billing system is arranged to communicate with a portal arranged to perform any of the steps of the method.

In a fifth aspect of the invention software is arranged to perform any of the steps of the method.

The portal and the system can comprise one or more modules. One or more modules can be provided to determine whether or not the content is already delivered but is deliverable again based on whether or not a time-out is reached. One or more modules can be provided to delete the ticket if the time-out is reached. One or more modules can be provided to determine whether or not the content is already delivered but is deliverable again based on whether or not a predefined number of downloads is reached. One or more modules can be provided to delete the ticket if the predefined number of downloads is reached. One or more modules can be provided to verify the credit of the terminal user by reading a credit threshold variable from the credit-information storage and/or checking if the credit threshold variable is at a predetermined value and/or requesting a credit check from the billing system and/or verifying if the credit of the terminal user is at a predetermined minimum level and/or stopping the billing and content delivery if the credit of the terminal user is at the predetermined minimum level. One or modules can be provided to validate the request for content by retrieving an information about the content from the information database and/or sending an acceptation page to the terminal and/or retrieving the acceptation statement from the terminal and/or checking the acceptation statement and/or stopping the billing and content delivery if the acceptation statement is negative or invalid and/or creating the ticket if the acceptation statement is positive and valid. One or more modules can be provided to deliver the content to the terminal user by retrieving the content from the content provider and/or sending the content to the terminal. One or more modules can be provided to deliver the content to the terminal by checking whether or not the content is retrieved correctly from the content provider and/or stopping the billing and content delivery if the content is not retrieved correctly from the content provider. One or more modules can be provided to change a variable keeping track of a number of downloads. One or more module can be provided for the billing of the content by sending billing data, e.g. an electronic billing record, to the billing system and/or checking whether or not the credit of the terminal user is at the predetermined minimum level and/or setting the credit threshold variable to the predetermined value if the credit of the terminal user is at the predetermined minimum level and/or finishing the billing and content delivery if the credit of the terminal user is not at the predetermined minimum level.

### BRIEF DESCRIPTION OF THE DRAWINGS

The invention will be explained in greater detail by reference to exemplary embodiments shown in the drawings, in which:

FIG. 1 shows the steps of the billing and content delivery process according to an exemplary embodiment of the invention;

FIG. 2 shows the steps within the first step of FIG. 1 according to an exemplary embodiment of the invention;

FIG. 3 shows the steps within the second step of FIG. 1 according to an exemplary embodiment of the invention;

FIG. 4 shows the steps within the third step of FIG. 1 according to an exemplary embodiment of the invention;

FIG. 5a shows the steps within the fourth step of FIG. 1 according to an exemplary embodiment of the invention;

FIG. 5b shows alternative steps within the fourth step of FIG. 1 according to an exemplary embodiment of the invention;

FIG. 6 shows the steps within the fifth step of FIG. 1 according to an exemplary embodiment of the invention;

FIG. 7 shows a portal and elements arranged to communicate with the portal for billing and content delivery according to an exemplary embodiment of the invention.

FIG. 8 shows a processor, a memory and a network connection within the portal.

### DETAILED DESCRIPTION OF THE INVENTION

For the purpose of teaching of the invention, preferred embodiments of the method and system of the invention are described in the sequel. It will be apparent to the person skilled in the art that other alternative and equivalent embodiments of the invention can be conceived and reduced to practice without departing from the true spirit of the invention, the scope of the invention being only limited by the claims as finally granted.

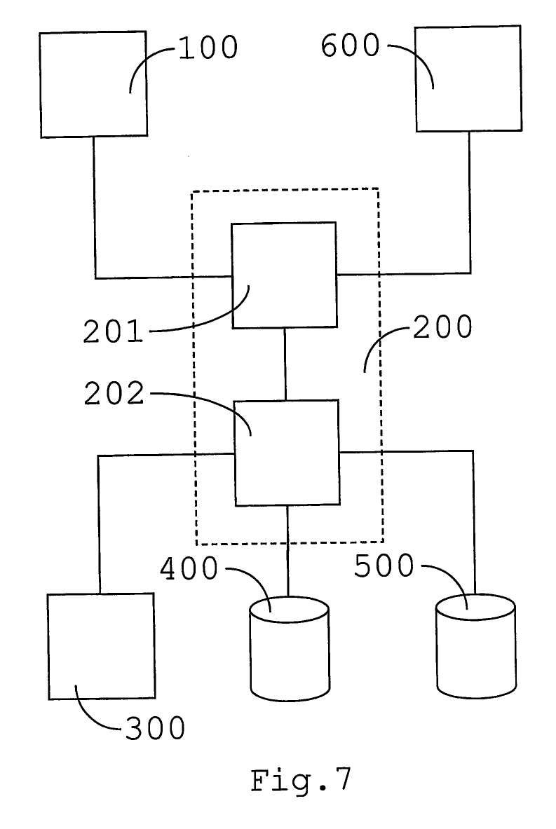

In FIG. 7 a portal (200) is shown, including its communication links to a terminal (100), a content provider (600), a billing system (300), a credit-information storage (400) and an information database (500). The communication links can be wireless or fixed links of any network type. A terminal user uses the terminal (100), which is capable of sending and retrieving data via a network, e.g. via Internet or a GPRS (General Packet Radio System) or a UMTS (Universal Mobile Telephony System) mobile network. It is possible that several networks are used, e.g. a combination of a GPRS network and the Internet. Examples of terminals are a pc, laptop, wap mobile phone, i-mode phone or set-top box. The terminal (100) retrieves content from content providers (600) via the portal (200). The portal (200) makes sure that the content is paid for when delivering it to the terminal (100). Often the content provider (600) is a third party specialized in content provisioning, but it is also possible that the content provider is part of the portal (200). A special kind of content is event-based content, for which there is payment obliged per event such as a page retrieval, access to content for a specific period of time, a maximum number of downloads, etcetera. The method, portal and system of the invention provide a solution for billing and event-based content delivery for content sent from the content provider (600) via the portal (200) to the terminal (100). The invention can be used for event-based billing and content delivery.

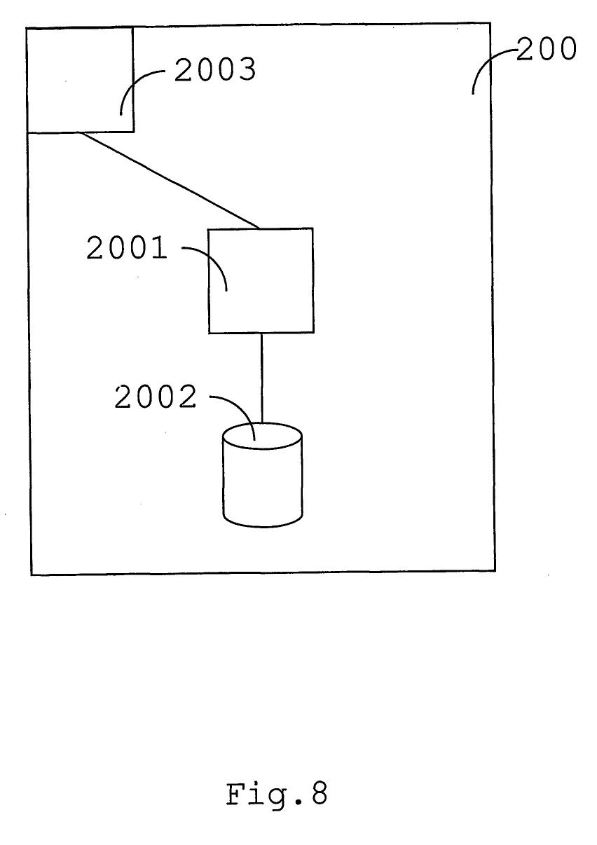

In FIG. 8 a processor (2001) for executing programs which are functional for the portal is shown. A memory (2002) for storing the executable programs and for storing variables is connected to the processor (2001). A network connection (2003) for sending content to the terminal (100) is controlled by the processor (2001).

In the best mode embodiment the portal (200) is separated into two parts: a front-end part (201) and a back-end part (202). This increases security by separating terminals (100) and content providers (600), both possibly residing outside the controlled and secured environment of the portal, from critical internal systems such as the billing system (300), credit-information storage equipment (400) and the information database (500).

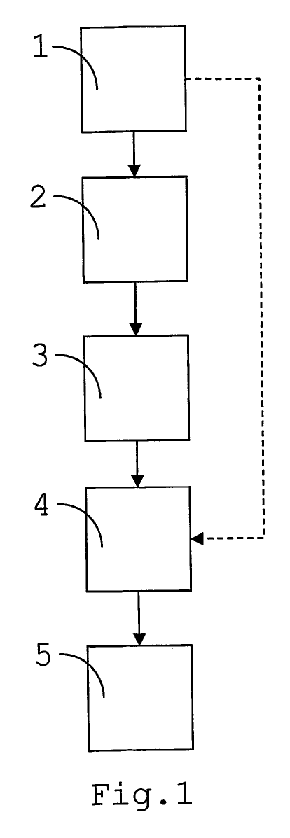

In FIG. 1 the steps of the billing and content delivery as processed in the portal are shown. With a request for content, e.g. event-based content, the process starts. The request is a HTTP (HyperText Transfer Protocol) request from the terminal (100) to the portal (200): GET http://portal/get?user_id&content_id.

In this request the id of the terminal user and the id of the requested event-based content is included.

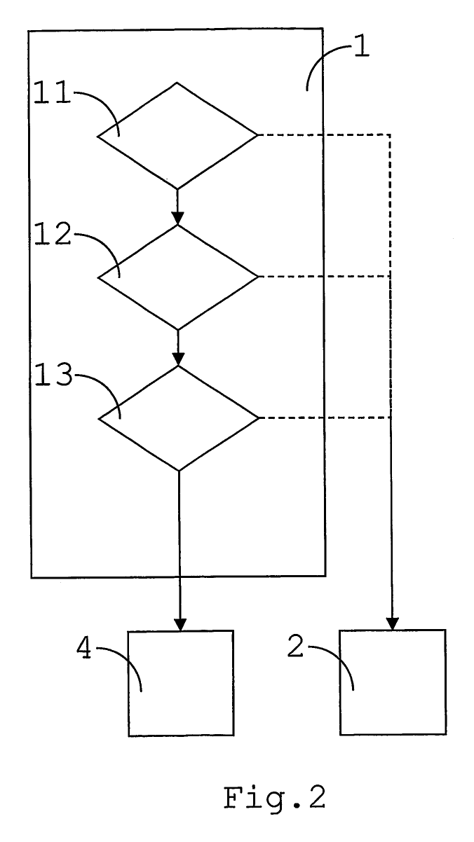

The request can be a first request, but is can also be a request after a failed previous request, a request because of a reload command at the terminal, or a valid subsequent request because a period of time has not elapsed yet or a maximum number of downloads is not reached yet. Therefore in a first step the status of the request is determined (1), see FIG. 1 and FIG. 2. If a ticket, i.e. a digital proof of payment stored in the portal, for the terminal user exists, which is checked in (11), for the requested content, a time-out value is checked (12) and the number of downloads is checked (13). Both are stored within the ticket. If all three checks are positive, the content can be delivered (4) to the terminal (100) immediately. Other criteria for determining the status of the request could be applied. As soon as the maximum time for using the content is reached, thus the time-out value is reached, the ticket is deleted. Also when the maximum number of downloads is reached the ticket is deleted. If at least one of the three checks is negative the process continues with the verification step (2).

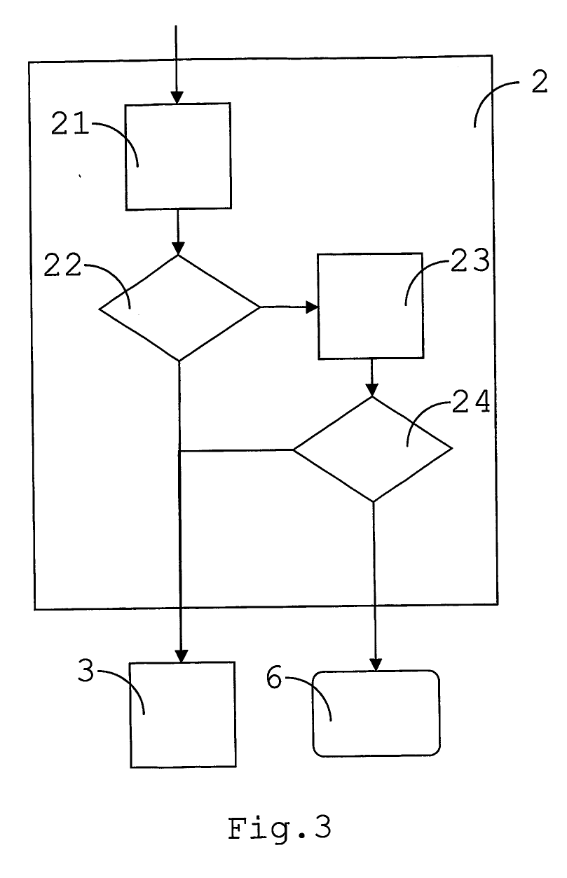

The verification (2) step, see FIG. 1 and FIG. 3, first checks a credit threshold variable by reading credit-information data from a speed-optimized LDAP (Lightweight Directory Access Protocol) storage (400), extracting (21) from the credit-information data the credit threshold variable, and checking (22) if the credit threshold variable is at a predetermined value. The credit threshold value indicates whether or not e.g. 90% of the credit of the terminal user is used. It is stored as: credit_threshold_reached=false|true.

Only when the threshold of 90% is reached a credit check is requested (23) from the billing system. This credit check is more resource and time consuming and should be performed as less as possible. If the outcome of the credit check (24) is that there is not enough credit left, the event-based billing and content delivery process is stopped (6) and a sorry-page is send to the terminal (100).

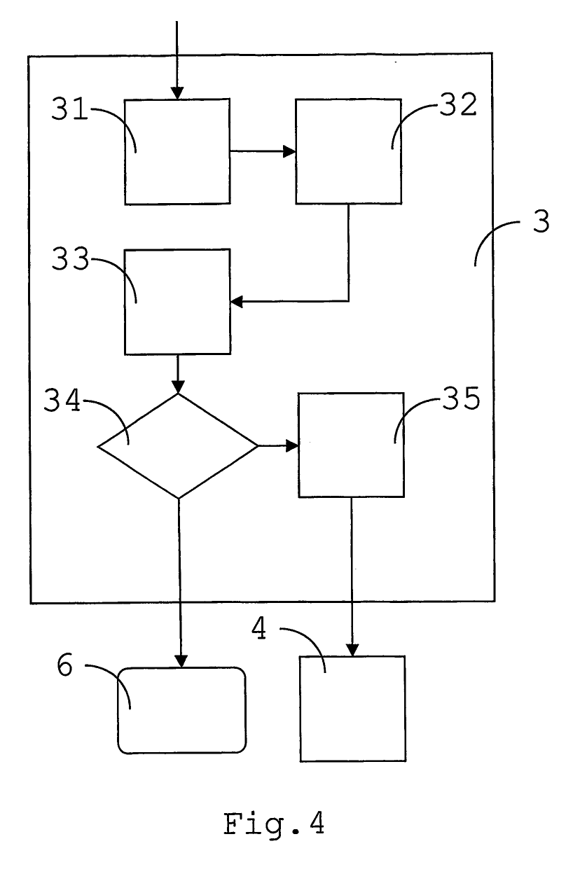

In the next step the content request is validated (3), see FIG. 1 and FIG. 4. Therefore content pricing information is retrieved (31) from an Oracle database (500) and sent (32) to the terminal (100) in a HTML (HyperText Markup Language) page. The HTML page includes a form for a pin code and an accept button. After retrieving (33) response from the terminal (100) the pin code is verified (34). If the pin code is invalid the terminal (100) is not allowed to retrieve the content and the event-based billing and content delivery process is stopped (6). A sorry page is then sent to the terminal (100). If the pin code is valid then a ticket is created (35) by storing the user_id/content_id in the portal. If there is a validity period defined for the content in the Oracle database (500), e.g. a validity period of one day, then that time-out value is stored within the ticket. Otherwise a default validity period of 60 seconds is stored. Likewise a maximum number of allowed downloads (i.e. number-of-downloads value) is stored, with a default of 1.

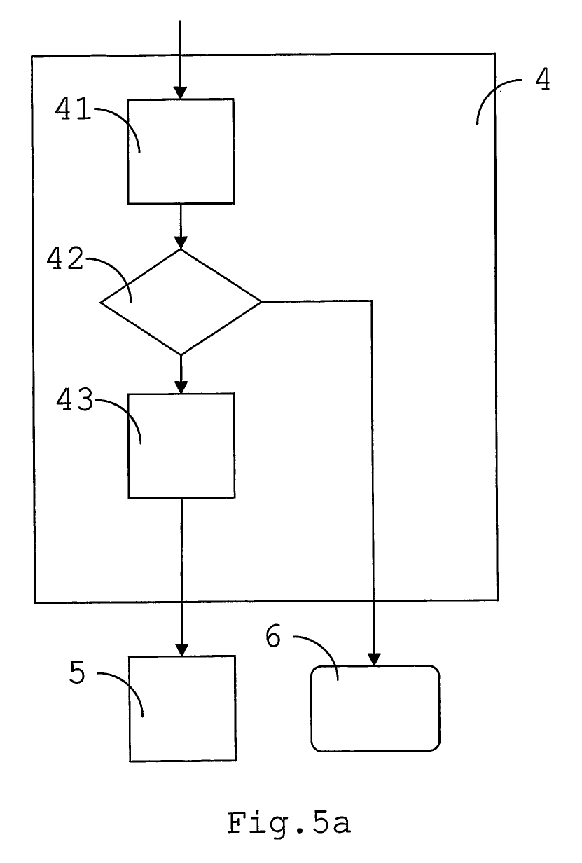

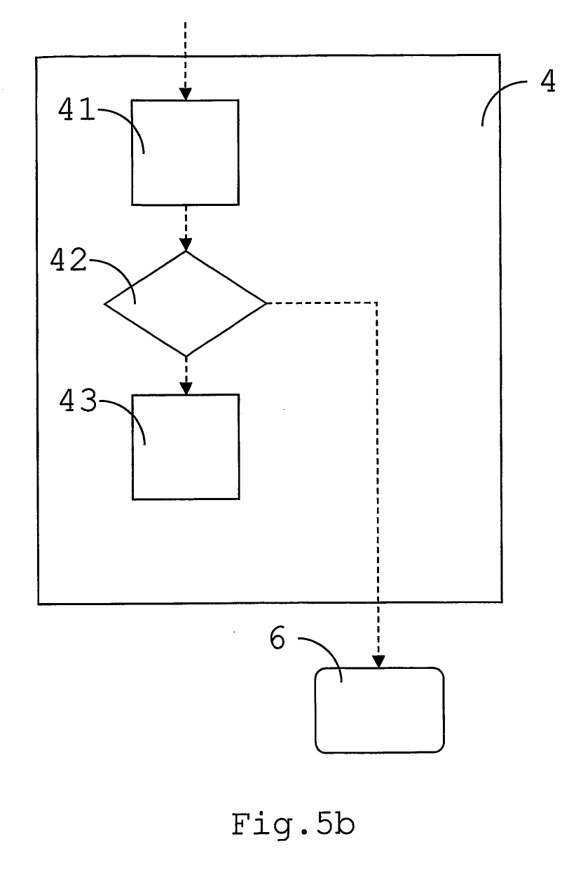

Next the content can be delivered (4) to the terminal (100), see FIG. 1 and FIG. 5b. After the content is received (41) in the front-end part (201) of the portal (200) from the content provider (600), the content retrieval is checked (42). If the content did not reach the portal intact, the event-based billing and content delivery process is stopped (6) and a sorry-page is sent to the terminal (100). Otherwise the content is sent (43) to the terminal (100) and the maximum number of downloads stored in the ticket is decreased with 1.

Whether or not the content reached the portal intact can be checked using known techniques for data transmission verification/error detection. Examples are CRC (Cyclic Redundancy Check), checksum calculation, FCS (Frame Check Sequence) and determining whether the structure of the content is correct.

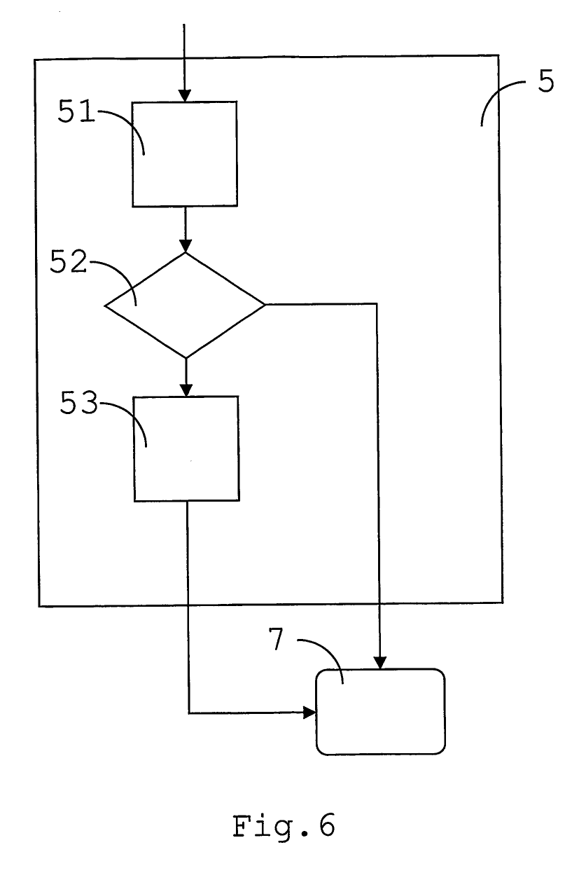

Only if the request from the terminal (100) was a first request the billing step (5) follows, see FIG. 1, FIG. 5a and FIG. 6. An electronic data record containing the user_id, content_id and timestamp is sent (51) to the billing system (300) where the price of the content is deducted from the credit. If the credit reaches the 90% threshold, thus only 10% of the credit is left, a notification is received back from the billing system (300) and the credit threshold value is set (53) in the LDAP storage (400). Otherwise the event-based billing and content delivery is finished (7). Whether or not the threshold is reached is determined in (52).

It is also possible that the portal checks regularly, e.g. once every hour, if the billing-credit in the billing system reaches the 90% threshold. This can be advantageous in case the billing-credit is not used solely by the portal, but also other systems can deduct money from the billing-credit. If the billing-credit reaches the 90% threshold, thus only 10% of the billing-credit is left, a notification is received back from the billing system (300) and the credit threshold value is set in the LDAP storage (400).

1. Method for billing and content delivery for a content requested by a terminal (100) of a terminal user to a portal (200), the method comprising the steps of
receiving a request for content by a processor (2001) in the portal (200),
determining (1) by the processor (2001) in the portal (200) whether or not the content is already delivered to the terminal (100) but is deliverable again based (11) on the existence of a digital ticket stored in a memory (2002) in the portal (200), the digital ticket indicating a digital proof of payment of the content;
if the content is not already delivered or not is deliverable again,
fetching a credit-information data of the terminal user from a credit-information storage (400) arranged to communicate with the portal (200), the credit-information storage (400) located separately from a billing system (300), the billing system (300) being arranged to communicate with the portal (200), and verifying (2) the credit-information data by the processor (2001) in the portal (200);
validating (3) the request for content by the processor (2001) in the portal (200);
delivering (4) the content from the portal (200) to the terminal (100) via a network;
billing (5) the content;
if the content is already delivered but is deliverable again,
delivering (4) the content from the portal (200) to the terminal (100) via the network.

2. Method according to claim 1 in which the determining (1) whether or not the content is already delivered but is deliverable again is based on whether or not a time-out is reached (12), which is determined by the processor (2001) by reading a time-out value from the memory (2002) in the portal (200).

3. Method according to claim 2 in which the method further comprises the step of
deleting the digital ticket from the memory (2002) by the processor (2001) if the time-out is reached.

4. Method according to claim 3 in which the determining (1) whether or not the content is already delivered but is deliverable again is based on whether or not a predefined number of downloads is reached (13), which is determined by the processor (2001) by reading a number-of-downloads value from the memory (2002) in the portal (200).

5. Method according to claim 4 in which the method further comprises the step of
deleting the digital ticket from the memory (2002) by the processor (2001) if the predefined number of downloads is reached.

6. Method according to claim 1 in which the verifying (2) of the credit-information data comprises the steps of
extracting (21) from the credit-information data a credit threshold variable by the processor (2001);
checking (22) if the credit threshold variable is at a predetermined value by the processor (2001);
if the credit threshold variable is at the predetermined value,
requesting (23) a billing credit check by fetching a billing credit-information data of the terminal user from the billing system (300) connected to the portal (200);
verifying (24) by the processor (2001) if the billing credit of the terminal user is at a predetermined minimum level, stopping (6) the billing and content delivery if the billing credit of the terminal user is at the predetermined minimum level.

7. Method according to claim 1 in which the validating (3) of the request for content comprises the steps of
retrieving (31) in the portal (200) information about the content from an information database (500) connected to the portal (200), the information comprising a price for the content;
sending (32) an acceptation page from the portal (200) to the terminal (100) via the network, the acceptation page comprising the price for the content, the acceptation page also comprising means for returning an acceptation statement for the price of the content;
retrieving (33) in the portal (200) the acceptation statement from the terminal (100);
checking (34) in the portal the acceptation statement, stopping (6) the billing and content delivery if the acceptation statement is negative or invalid;
creating (35) the digital ticket in the memory (2002) by the processor (2001) if the acceptation statement is positive and valid.

8. Method according to claim 7 in which the acceptation statement includes a pin code.

9. Method according to claim 1 in which the delivering (4) of the content to the terminal (100) comprises the steps of
retrieving (41) in the portal (200) the content from a content provider (600) connected to the portal (200);
sending (43) the content from the portal (200) to the terminal (100) via the network.

10. Method according to claim 9 in which the delivering (4) of the content to the terminal (100) further comprises the step of
checking (42) by the processor (2001) whether or not the content is retrieved intact in the portal (200) from the content provider (600), stopping (6) the billing and content delivery if the content is not retrieved intact from the content provider (600).

11. Method according to claim 10 in which the delivering (4) of the content to the terminal further comprises the step of
changing the number-of-downloads variable in the memory (2002) by the processor (2001).

12. Method according to claim 6 in which the billing (5) of the content comprises the steps of
sending (51) a billing data to the billing system (300);
checking (52) whether or not the billing credit of the terminal user is at the predetermined minimum level;
setting (53) in the credit-information storage (400) by the processor (2001) the credit threshold variable to the predetermined value if the billing credit of the terminal user is at the predetermined minimum level;
finishing (7) the billing and content delivery if the billing credit of the terminal user is not at the predetermined minimum level.

13. Portal for billing and content delivery for a content requested by a terminal (100) of a terminal user, the portal (200) being arranged to communicate with
the terminal (100),
a content provider (600) comprising said content,
a billing system (300),
a credit-information storage (400) located separately from said billing system (300), the credit-information storage (400) comprising credit-information, and
an information database (500) comprising information related to the content,
the portal (200) comprising
a processor (2001) for executing programs which are functional for the portal (200),
a memory (2002) connected to the processor (2001) for storing the executable programs and for storing variables, and
a network connection (2003), controllable by the processor (2001), for sending the content to the terminal (100),
whereby the processor (2001) is arranged to determine the existence of a digital ticket stored in the memory (2002) in the portal (200), the digital ticket indicating a digital proof of payment of the content;
the processor (2001) is arranged to fetch a credit-information data of the terminal user from the credit-information storage (400) and verify the credit-information data;
the processor (2001) is arranged to validate the request for content;
the portal (200) is arranged to deliver the content to the terminal (100);
the portal (200) is arranged to bill the content.

14. Portal according to claim 13 in which the portal (200) comprises a front-end part (201) and a back-end part (202), the front-end part (201) being connected to
the terminal (100) and
the content provider (600),
the back-end part (202) being connected to
the billing system (300),
the credit-information storage (400) and
the information database (500).

15. Portal according to claim 14 in which the processor (2001) is arranged to determine whether or not the content is already delivered but deliverable again based on whether or not a time-out is reached by reading a time-out value from the memory (2002).

16. Portal according to claim 15 in which the processor (2001) is arranged to delete the digital ticket from the memory (2002) if the time-out is reached.

17. Portal according to claim 16 in which the processor (2001) is arranged to determine whether or not the content is already delivered but deliverable again based on whether or not a predefined number of downloads is reached by reading a number-of-downloads value from the memory (2002).

18. Portal according to claim 17 in which the processor (2001) is arranged to delete the digital ticket from the memory (2002) if the predefined number of downloads is reached.

19. Portal according to claim 15 in which
the processor (2001) is arranged to extract from the credit-information data a credit threshold variable;
the processor (2001) is arranged to check if the credit threshold variable is at a predetermined value;
the processor (2001) is arranged to request a billing credit check by fetching a billing credit check data of the terminal user from the billing system (300);
the processor (2001) is arranged to verify if the billing credit of the terminal user is at a predetermined minimum level, and to stop the billing and content delivery if the billing credit of the terminal user is at the predetermined minimum level.

20. Portal according to claim 15 in which
the portal (200) is arranged to retrieve information about the content from the information database (500), the information comprising a price for the content;
the portal (200) being arranged to send an acceptation page to the terminal (100) via the network connection (2003), the acceptation page comprising the price for the content, the acceptation page also comprising means for returning an acceptation statement for the price of the content;
the portal (200) being arranged to retrieve the acceptation statement from the terminal (100);
the portal (200) being arranged to check the acceptation statement, and to stop the billing and content delivery if the acceptation statement is negative or invalid;
the processor (200) being arranged to create the digital ticket in the memory (2002) if the acceptation statement is positive and valid.

21. Portal according to claim 20 in which the acceptation statement includes a pin code.

22. Portal according to claim 15 in which
the portal (200) is arranged to retrieve the content from the content provider (600);
the portal (200) is arranged to send the content to the terminal (100) via the network connection (2003).

23. Portal according to claim 22 in which
the processor (2001) is arranged to check whether or not the content is retrieved correctly from the content provider (600), and to stop the billing and content delivery if the content is not retrieved correctly from the content provider (600).

24. Portal according to claim 23 in which the processor (2001) is arranged to change the number-of-downloads variable in the memory (2002).

25. Portal according to claim 21 in which
the processor (2001) is arranged to set in the credit-information storage (400) the credit threshold variable to the predetermined value if the billing credit of the terminal user is at the predetermined minimum level;
the portal (200) is arranged to finish the billing and content delivery if the billing credit of the terminal (100) is not at the predetermined minimum level.

26. System for billing and content delivery for a content requested by a terminal (100) of a terminal user, the system comprising a portal (200) and a credit-information storage (400), the portal (200) being arranged to communicate with
the terminal (100),
a content provider (600) comprising said content,
a billing system (300),
the credit-information storage (400) located separately from said billing system (300), the credit-information storage (400) comprising credit-information, and
an information database (500) comprising information related to the content,
the portal (200) comprising
a processor (2001) for executing programs which are functional for the portal (200),
a memory (2002) connected to the processor (2001) for storing the executable programs and for storing variables, and
a network connection (2003), controllable by the processor (2001), for sending the content to the terminal (100),
whereby the processor (2001) is arranged to determine the existence of a digital ticket stored in the memory (2002) in the portal (200), the digital ticket indicating a digital proof of payment of the content;
the processor (2001) is arranged to fetch a credit-information data of the terminal user from the credit-information storage (400) and verify the credit-information data;
the processor (2001) is arranged to validate the request for content;
the portal (200) is arranged to deliver the content to the terminal (100);
the portal (200) is arranged to bill the content.

27. Billing system arranged to communicate with a portal for billing and content delivery for a content requested by a terminal (100) of a terminal user, the portal (200) being arranged to communicate with
the terminal (100),
a content provider (600) comprising said content,
a credit-information storage (400) located separately from said billing system (300), the credit-information storage (400) comprising credit-information, and
an information database (500) comprising information related to the content,
the portal (200) comprising
a processor (2001) for executing programs which are functional for the portal (200),
a memory (2002) connected to the processor (2001) for storing the executable programs and for storing variables, and
a network connection (2003), controllable by the processor (2001), for sending the content to the terminal (100),
whereby the processor (2001) is arranged to determine the existence of a digital ticket stored in the memory (2002) in the portal (200), the digital ticket indicating a digital proof of payment of the content;
the processor (2001) is arranged to fetch a credit-information data of the terminal user from the credit-information storage (400) and verify the credit-information data;
the processor (2001) is arranged to validate the request for content;
the portal (200) is arranged to deliver the content to the terminal (100);
the portal (200) is arranged to bill the content.

28. Software for billing and content delivery for a content requested by a terminal (100) of a terminal user, the software running in a portal (200) being arranged to communicate with
the terminal (100),
a content provider (600) comprising said content,
a billing system (300),
a credit-information storage (400) located separately from said billing system (300), the credit-information storage (400) comprising credit-information, and
an information database (500) comprising information related to the content,
the portal (200) comprising
a processor (2001) for executing the software,
a memory (2002) connected to the processor (2001) for storing the software and for storing variables, and
a network connection (2003), controllable by the processor (2001), for sending the content to the terminal (100),
whereby the processor (2001) is arranged to determine the existence of a digital ticket stored in the memory (2002) in the portal (200), the digital ticket indicating a digital proof of payment of the content;
the processor (2001) is arranged to fetch a credit-information data of the terminal user from the credit-information storage (400) and verify the credit-information data;
the processor (2001) is arranged to validate the request for content;
the portal (200) is arranged to deliver the content to the terminal (100);
the portal (200) is arranged to bill the content.
